(19) United States
(12) Patent Application Publication
(10) Pub. No.: US 2024/0386217 A1
(43) Pub. Date: Nov. 21, 2024

(54) Entertainment Character Interaction Quality Evaluation and Improvement

(71) Applicant: Disney Enterprises, Inc., Burbank, CA (US)

(72) Inventors: Erika Varis Doggett, Los Angeles, CA (US); Laurel Goodhart, Portland, OR (US); Maike Paetzel-Pruesmann, Zurich (CH); Graziana Mignone, Schlieren (CH); Lorenzo Puppi Vecchi, Curitiba (BR); Erick Moen, El Segundo, CA (US)

(21) Appl. No.: 18/593,725

(22) Filed: Mar. 1, 2024

Related U.S. Application Data
(60) Provisional application No. 63/467,847, filed on May 19, 2023.

(51) Int. Cl. G06F 40/40

(52) U.S. Cl. CPC G06F 40/40

(57) ABSTRACT

A system includes a processor and a memory storing software code. The processor executes the software code to receive dialogue data identifying a character, a storyline including the character, and speech for the character intended to advance the storyline or achieve a goal, assess, using the dialogue data, quality assurance (QA) metrics of the speech including at least one of: (i) its fluency, (ii) its responsiveness to speech by an interaction partner of the character, (iii) its consistency with the goal, (iv) its consistency with a character profile of the character, or (v) or its consistency with a story-world of the storyline, and determine, using the QA metrics, whether the speech is suitable for advancing the storyline or achieving the goal. When determining determines that the speech is suitable, approve the speech. When determining determines that the speech is unsuitable, flag the speech as unsuitable.

### RELATED APPLICATIONS

The present application claims the benefit of and priority to a pending U.S. Provisional Patent Application Ser. No. 63/467,847 filed on May 19, 2023, and titled “Artificial Intelligence Character Interaction Quality Evaluation and Improvement,” which is hereby incorporated fully by reference into the present application.

### BACKGROUND

Recent work in generative language modeling has inspired explorations into character dialogue generation that is more flexible than conventional pre-authored dialogue tree approaches, and can generate a wide range of character responses quickly and easily. However, measuring the quality of those model generated responses is underdeveloped in the existing art, leaving designers to either use metrics unsuited for character interactions and missing key components of what makes the persona of a character distinctive, or alternatively to not use metrics at all and rely purely on the internal probabilistic values produced by the model with no external judgment.

Previous metrics for judging in-character consistency have sometimes used an entailment model, but fail to account for in-world consistency, i.e., whether the interactions of the character are consistent with the historical time and location of that character, or whether the character is staying consistent to a goal of an interaction. Moreover, existing work tends to be heavily focused on content-level metrics like toxicity and truthfulness. Outside of those content-level metrics, engineers and researchers have largely been limited to surface-level metrics such as grammar and semantics, and the current dominant metric used for evaluating large language models (i.e., perplexity), which corresponds to internal likelihood consistency for sentence structure, and is insufficient for judging any of the metrics important to character development.

### BRIEF DESCRIPTION OF THE DRAWINGS

FIG. 1 shows an exemplary system for performing entertainment character interaction quality evaluation and improvement, according to one implementation;

FIG. 2A shows a more detailed diagram of an input unit suitable for use as a component of the system shown in FIG. 1, according to one implementation;

FIG. 2B shows a more detailed diagram of an output unit suitable for use as a component of the system shown in FIG. 1, according to one implementation;

FIG. 3A shows an exemplary display pane of a user interface (UI), the display pane describing an entertainment character (hereinafter “character”), the story-world of the character, and the context and goal of an interaction by the character, as well as a dialogue history of the character and a continuation of the dialogue, according to one implementation;

FIG. 3B shows another exemplary display pane of the UI of FIG. 3A that elicits inputs from a system administrator, in the form of comments and/or a series of yes/no evaluations of the continuation of the dialogue shown in FIG. 3A, according to one implementation;

FIG. 4 shows a flowchart presenting an exemplary method for performing character interaction quality evaluation, according to one implementation;

FIG. 5 shows a flowchart describing additional actions for assessing the consistency of speech generated for a character with a character profile of the character, according to one implementation; and

FIG. 6 shows a diagram depicting character trait clusters for different characters relative to Big 5 personality traits, according to one implementation.

### DETAILED DESCRIPTION

The following description contains specific c information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application addresses the deficiencies in the conventional art described above in the Background section by introducing multiple Quality Assurance (QA) metrics, which in some implementations may be combined to provide an integrated multi-faceted evaluation metric. Those QA metrics or that multi-faceted metric may be used to judge the quality of fit of generative language models to a specified character, which may be an artificial intelligence (AI) character or a human performer assuming the role of the character for example, where such a character may be a fictional or non-fictional character. The QA metrics and multi-faceted evaluation metric disclosed herein provide a basis for better model research in the future, and allow for potential control along those metrics or along the individual facets of the multi-faceted evaluation metric for improvement of the model, such that character speech is consistent with human conversational behavior and with the communication goals of the character, as well as consistent with the character profile, e.g., personality and knowledge, of the character. Moreover, in some use cases, the character interaction quality evaluation and improvement solution disclosed by the present application may advantageously be implemented as substantially automated systems and methods.

As used in the present application, the terms “automation,” “automated” and “automating” refer to systems and processes that do not require the participation of a human developer or system administrator. Although in some implementations the evaluations generated by the systems and methods disclosed herein may be reviewed or even modified by a human, that human involvement is optional. Thus, the methods described in the present application may be performed under the control of hardware processing components of the disclosed systems.

With respect to the feature “AI character,” it is noted that as defined in the present application, an AI character refers to a non-human social agent that exhibits behavior and intelligence that can be perceived by a human who interacts with the AI character as a unique individual with its own personality. AI characters may be implemented as machines or other physical devices, such as robots or toys, or may be virtual entities, such as digital characters presented by animations on a screen or disembodied characters represented by text, audio, or text and audio. AI characters may speak with their own characteristic voice (e.g., phonation, pitch, loudness, rate, dialect, accent, rhythm, inflection and the like) such that a human observer recognizes the AI character as a unique individual. AI characters may exhibit characteristics of living or historical characters, fictional characters from literature, film and the like, or simply unique individuals that exhibit patterns that are recognizable by humans as a personality.

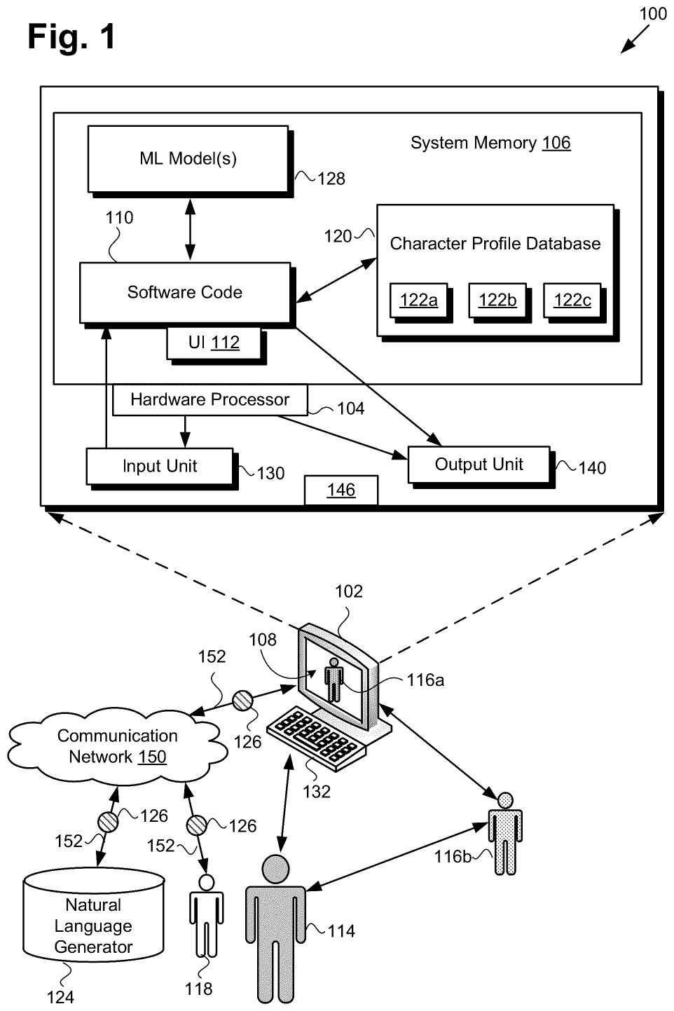

FIG. 1 shows a diagram of system 100 for performing AI character interaction evaluation and improvement, according to one exemplary implementation. As shown in FIG. 1, system 100 includes computing platform 102 having hardware processor 104, input unit 130 including input device 132, output unit 140 including display 108, transceiver 146, and system memory 106 implemented as a non-transitory storage medium. According to the present exemplary implementation, system memory 106 stores software code 110 providing user interface (UI) 112, character profile database 120 including character profiles 122a, 122b and 122c, and one or more trained ML models 128 (hereinafter “ML model(s) 128”), which may be or include one or more of a regression model, large language model, or multimodal foundation model for example.

As further shown in FIG. 1, system 100 is implemented within a use environment including communication network 150 providing network communication links 152, and Natural Language Generator (NLG) 124, which may be or include one or more of a large language model or a multimodal foundation model, communicatively coupled to system 100 via communication network 150 and network communication links 152. Also shown in FIG. 1 are human speaker 114, AI characters 116a and 116b, human performer 118, and dialogue data 126 received by system 100 from NLG 124 or human performer 118.

It is noted that, as defined in the present application, the expression “ML model” refers to a computational model for making predictions based on patterns learned from samples of data or “training data.” Various learning algorithms can be used to map correlations between input data and output data. These correlations form the computational model that can be used to make future predictions on new input data. Such a predictive model may include one or more logistic regression models, Bayesian models, transformer-based models, large language models, multimodal foundation models, or artificial neural networks (NNs), for example. Moreover, a “deep neural network,” in the context of deep learning, may refer to an NN that utilizes multiple hidden layers between input and output layers, which may allow for learning based on features not explicitly defined in raw data. As used in the present application, any feature identified as an NN refers to a deep neural network.

It is further noted that although FIG. 1 depicts AI character 116a as being instantiated as a digital character rendered on display 108, and depicts AI character 116b as a robot, those representations are provided merely by way of example. In other implementations, one or both of AI characters 116a and 116b may be instantiated by devices, such as audio speakers, displays, or figurines, to name a few examples. It is also noted that AI character 116b corresponds in general to AI character 116a and may include any of the features attributed to AI character 116a. Moreover, although not shown in FIG. 1, like computing platform 102, in some implementations AI character 116b may include hardware processor 104, input unit 130, output unit 140, and system memory 106 storing software code 110, character profile database 120, and ML model(s) 128.

Furthermore, although FIG. 1 depicts one human speaker 114, one human performer 118, and two AI characters 116a and 116b, that representation is merely exemplary. In other implementations, any combination of one AI character, two AI characters, more than two AI characters, and one or more human performers may engage in dialogue with one or more human beings corresponding to human speaker 114. Alternatively, in various implementations, two or more AI characters, such as AI characters 116a and 116b, may be engaged in a conversation in which human beings do not participate, from which human beings are excluded, or in which human beings participate merely as non-speaking observers. It is also noted that although FIG. 1 depicts three character profiles 122a, 122b and 122c, character profile database 120 will typically store tens, hundreds, or thousands of character profiles.

Although the present application refers to software code 110, character profile database 120 and ML model(s) 128 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

Moreover, in some implementations, system 100 may utilize a decentralized secure digital ledger in addition to system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

It is further noted that although FIG. 1 depicts software code 110, character profile database 120 and ML model(s) 128 as being co-located in system memory 106, that representation is also merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100. Consequently, in some implementations, software code 110, character profile database 120, and ML model(s) 128 may be stored remotely from one another on the distributed memory resources of system 100. Furthermore, although FIG. 1 depicts NLG 124 as being a remote resource accessible by system 100 using communication network 150, in some implementations, NLG 124 may be a component of system 100 and may be stored within the memory resources of system 100.

Although in some implementations, as shown in FIG. 1, system 100 may be implemented as a personal computing device, in other implementations computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of private or limited distribution network.

When implemented as a personal computing device, as shown in FIG. 1, computing platform 102 of system 100 may take the form of a desktop computer, or any other suitable mobile or stationary computing system that implements data processing capabilities sufficient to provide a user interface, and implement the functionality attributed to computing platform 102 herein. For example, in other implementations, computing platform 102 may take the form of a laptop computer, tablet computer, smartphone, or an augmented reality (AR) or virtual reality (VR) device, for example, providing display 108. Display 108 may take the form of a liquid crystal display (LCD), a light-emitting diode (LED) display, an organic light-emitting diode (OLED) display, a quantum dot (QD) display, or any other suitable display screen that performs a physical transformation of signals to light.

It is also noted that although FIG. 1 shows input unit 130 as including input device 132, output unit 140 as including display 108, and both input unit 130 and output unit 140 as residing on computing platform 102, those representations are merely exemplary as well. In other implementations including an all-audio interface, for example, input unit 130 may be implemented as a microphone, while output unit 140 may take the form of an audio speaker. Moreover, in implementations in which AI character 116b takes the form of a robot or other type of machine, input unit 130 and/or output unit 140 may be integrated with AI character 116b rather than with computing platform 102. In other words, in some implementations, AI character 116b may include one or both of input unit 130 and output unit 140.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for AI applications such as machine learning modeling.

Input device 132 of system 100 may include any hardware and software enabling human speaker 114 to enter data into system 100. Examples of input device 132 may include a keyboard, trackpad, joystick, touchscreen, or voice command receiver, to name a few.

Transceiver 146 may be implemented as a wireless communication unit configured for use with one or more of a variety of wireless communication protocols. For example, transceiver 146 may include a fourth generation (4G) wireless transceiver and/or a 5G wireless transceiver. In addition, or alternatively, transceiver 146 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

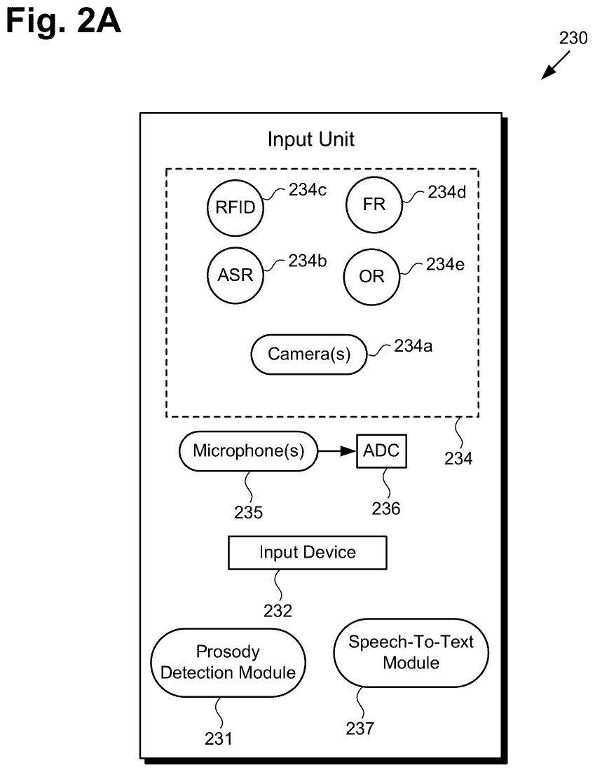

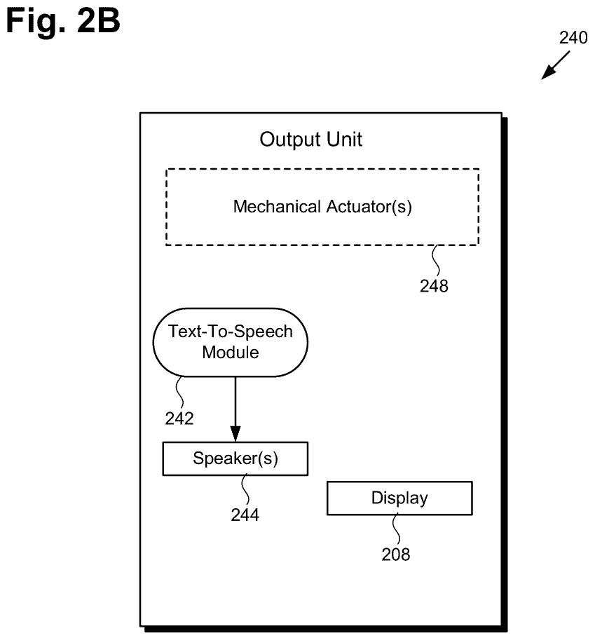

FIG. 2A shows a more detailed diagram of input unit 230 suitable for use as a component of system 100, in FIG. 1, according to one implementation. As shown in FIG. 2A, input unit 230 may include prosody detection module 231, input device 232, multiple sensors 234, one or more microphones 235 (hereinafter “microphone(s) 235”), analog-to-digital converter (ADC) 236, and Speech-To-Text (STT) module 237. It is noted that, as used herein, the term “prosody” has its customary meaning in the art. That is to say, prosody refers to the patterns of stress and intonation in speech, and may include loudness, pitch, timbre, cadence, the speed with which the speech is delivered, and the like.

As further shown in FIG. 2A, sensors 234 of input unit 230 may include one or more cameras 234a (hereinafter “camera(s) 234a”), automatic speech recognition (ASR) sensor 234b, radio-frequency identification (RFID) sensor 234c, facial recognition (FR) sensor 234d, and object recognition (OR) sensor 234e. Input unit 230 and input device 232 correspond respectively in general to input unit 130 and input device 132, in FIG. 1. Thus, input unit 130 and input device 132 may share any of the characteristics attributed to respective input unit 230 and input device 232 by the present disclosure, and vice versa.

It is noted that the specific features shown to be included in input unit 130/230 are merely exemplary, and in other implementations, input unit 130/230 may include more, or fewer, features than prosody detection module 231, sensors 234, microphone(s) 235, ADC 236, and STT module 237. Moreover, in some implementations, sensors 234 may include a sensor or sensors other than one or more of camera(s) 234a, ASR sensor 234b, RFID sensor 234c, FR sensor 234d, and OR sensor 234e. It is further noted that, when included among sensors 234 of input unit 130/230, camera(s) 234a may include various types of cameras, such as red-green-blue (RGB) still image and video cameras, RGB-D cameras including a depth sensor, and infrared (IR) cameras, for example.

FIG. 2B shows a more detailed diagram of output unit 240 suitable for use as a component of system 100, in FIG. 1, according to one implementation. As shown in FIG. 2B, output unit 240 may include one or more of Text-To-Speech (TTS) module 242 in combination with one or more audio speakers 244 (hereinafter “speaker(s) 244”), and display 208. As further shown in FIG. 2B, in some implementations, output unit 240 may include one or more mechanical actuators 248 (hereinafter “mechanical actuator(s) 248”). It is further noted that, when included as a component or components of output unit 240, mechanical actuator(s) 248 may be used to produce facial expressions by AI character 116b, and/or to articulate one or more limbs or joints of AI character 116b. Output unit 240 and display 208 correspond respectively in general to output unit 140 and display 108, in FIG. 1. Thus, output unit 140 and display 108 may share any of the characteristics attributed to output unit 240 and display 208 by the present disclosure, and vice versa.

It is noted that the specific features shown to be included in output unit 140/240 are merely exemplary, and in other implementations, output unit 140/240 may include more, or fewer, features than TTS module 242, speaker(s) 244, display 208, and mechanical actuator(s) 248. Moreover, in other implementations, output unit 140/240 may include a feature or features other than one or more of TTS module 242, speaker(s) 244, display 208, and mechanical actuator(s) 248. As noted above, display 108/208 of output unit 140/240 may be implemented as an LCD, LED display, OLED display, a QD display, or any other suitable display screen that perform a physical transformation of signals to light.

Referring to FIG. 1, it is noted that system 100 is configured to perform a multi-faceted evaluation of generative language models, such as NLG 124 for example, where that evaluation may include five main QA metrics, for example, some or all of which may be broken down further into sub-components for targeted evaluative annotation, as described below. Those five main QA metrics include: (1) sensical—assessing whether the character speech makes sense, (2) engagement—assessing whether the speech is compelling or otherwise engaging, (3) goal oriented—assessing whether the speech advances a goal of the character interaction, (4) in-character—assessing whether the speech is consistent with the character profile of the character, and (5) in-world—assessing whether the speech is consistent with the story-world inhabited by the character. The five main QA metrics are further described below.

The sensical QA metric assess whether an interaction by a character makes sense. There may be multiple aspects to what makes sense, including the sub-components of fluency and dialogue context. With respect to fluency, an assessment is performed to determine whether speech is grammatical and coherent, or ungrammatical or incoherent. It is noted that some conventional NLGs may sometimes still produce disfluent sentences or sentences with ungrammatical phrasing. Regarding dialogue context, the assessment is directed to whether generated dialogue is consistent or relevant to preceding speech by the character and the interaction partner of the character during the dialogue. This context consistency metric seeks to detect inconsistencies such as non sequiturs, repetitive responses, mistakes in reference resolution, and similar erroneous language behavior.

The engagement QA metric assesses whether the content of speech is engaging. Good interactive characters should be engaging, responsive to their interaction partners and entertaining. If a character ignores what their interaction partner has said, this is a sign that the character is not engaged in the dialogue, making the interaction partner feel like their input does not matter, and breaking the illusion of a real-life interaction. Moreover, character speech may be relevant and responsive to previous speech, but may yet be boring or uninteresting. For example, if an interaction partner of a character opts to terminate a dialogue early—for example, before an interaction goal is reached—this is an indication that the content is insufficiently engaging. The engagement component may include the subcomponents attentiveness, i.e., whether the interaction partner feels heard, and continuation, i.e., whether the continuation of the dialogue by the character keeps the interaction partner immersed in the dialogue.

The goal-oriented QA metric assesses whether the generated speech is consistent with or relevant to an established goal that the character may have for the interaction. This metric is useful for scenarios in which an AI character has a purpose within a storyline, and a purpose at the moment in time of the interaction. Having a purpose, establishing stakes in an interaction, and following a storyline are important for creating an entertaining experience. It is noted that the goal of the character may be predetermined by a human programmer or editor, based on the storyline or story-world inhabited by the character, for example. Moreover, a plurality of different goals may be predetermined for different types of interactions in which the character may participate. The interaction goal may be expressed as a pre-set tag, a short phrase, sentence, or vector, among other implementations.

It is noted that not every sentence of speech needs be related to the overall interaction goal. Characters can and should move the conversation forward in a natural way, even if that means not explicitly talking about their goal, but they should always come back to attempt to achieve their goal by the end of the interaction. To capture this behavior, the interaction goal component may include the sub-components of advancement, i.e., whether the continued speech move the interaction forward, and goal violation, i.e., does the continued speech violate the interaction goal? For example, if the interaction goal is that the character wants to end the dialogue, that character would not say “Oh, really? Tell me more” as that would violate the goal of ending the dialogue.

The in-character QA metric assesses whether the interaction is “in-character” with the personality of the character. Different characters should respond to stimuli in different ways. For example, some characters may be suspicious or rude, while other characters may be patient and kind. The personality as well as typical character phrases may be targeted with this metric. In addition, this metric may include evaluating adherence to established facts about the character and the background of the character, such as the age, gender, and other demographic characteristics relevant to the personality of the character, as well as, in some implementations, the species of the character, e.g., human, dog, cat, fish, bird, dinosaur, or space alien to name a few.

The in-world QA metric assesses whether the generated speech is “in-world.” Many characters exist within a story-world that may be quite different from the present real world. In order to avoid breaking the immersion of an interaction, an agent representing a 19^{th} century English character, for example, should not “know” what an iPhone is, but will know what a “hansom” is (a horse-drawn cab).

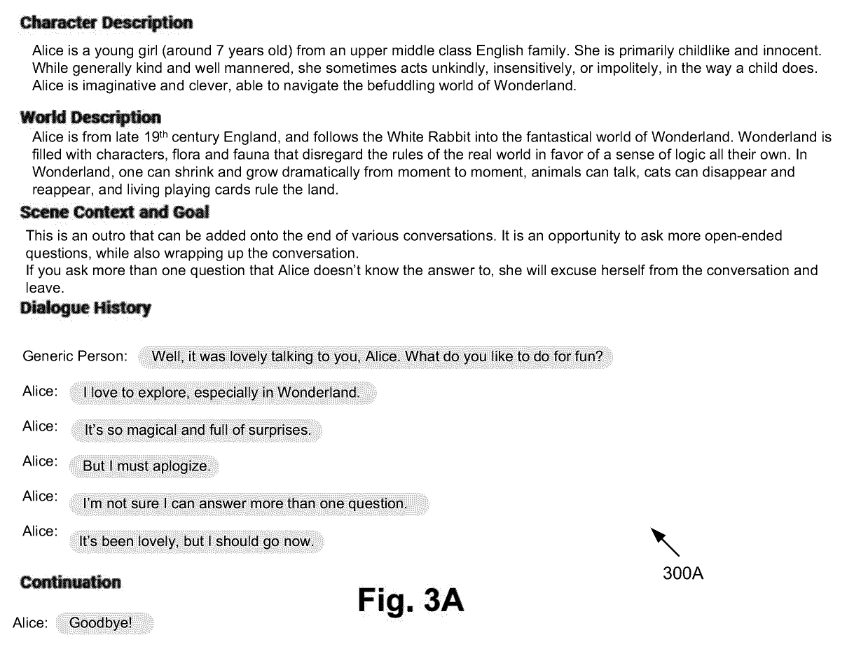

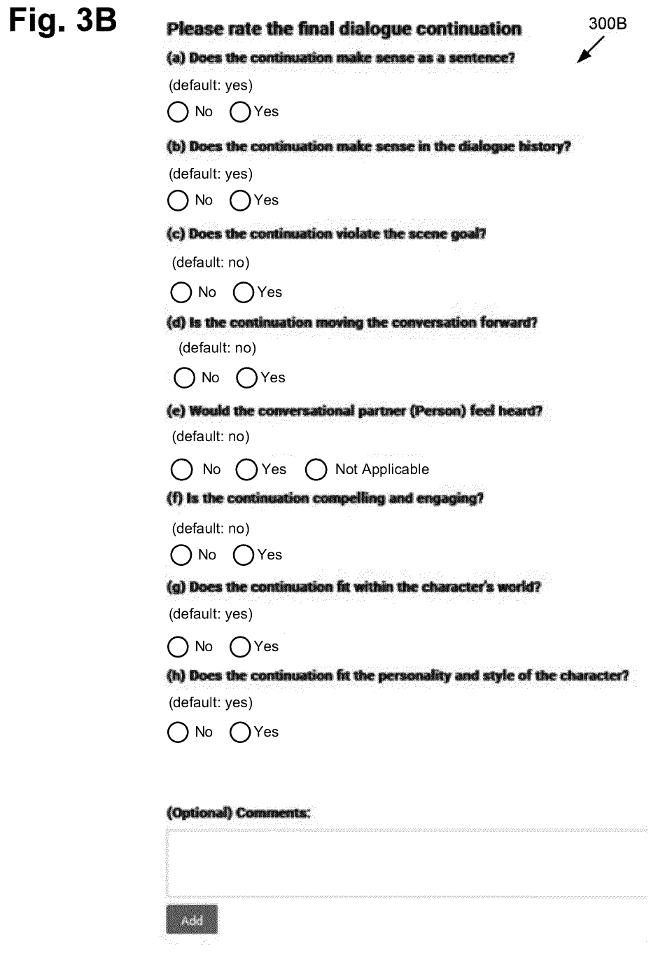

The above framework may be implemented for manual evaluation (e.g., data dialogue annotation with human annotators or taggers), or each QA metric may be captured using a variety of automated methods. Referring to FIG. 1, for manual evaluation, UI 112 provided by software code 110 may be configured to represent an interaction in the form of a dialogue in snippets of the dialogue. FIG. 3A shows exemplary display pane 300A of UI 112, display pane 300A describing a character, the story-world of the character, and the context and goal of an interaction by the character, as well as a dialogue history of the character and a continuation of the dialogue, according to one implementation.

Subsequent display pane 300B of UI 112, shown in FIG. 3B, elicits inputs from a system administrator of system 100, such as a programmer or language editor for example, in the form of comments and/or a series of yes/no evaluations of the continuation of the dialogue shown in FIG. 3A, according to one implementation. It is noted that, although FIG. 3B shows questions permitting a binary yes/no response, as well as question (e) providing “Not Applicable” as an alternative response, that representation is merely exemplary. In other implementations, display pane 300B may request evaluations in the form of a rating on a numerical scale, such as a Likert scale for example. It is further noted that the human review and evaluation of the dialogue continuation represented in FIG. 3B may be used to modify or otherwise update some or all of the QA metrics or the multi-faceted QA metric used to determine the suitability of speech by a character that is intended to advance a particular storyline.

Alternatively, or in addition, in the case of automated evaluation of the speech generated by NLG 124, several approaches are contemplated. For example, multiple classifiers, or a single multi-class classifier included among ML model(s) 128, can be trained to predict values for each of the above QA metrics based on previously collected manual evaluation data.

As another alternative, or in addition, sentence clusters plus similarity scores, such as transformer-based similarity scores for example, may be used for judging whether character speech is “in-world,” wherein a clustering analysis may be performed on a larger body of text prior to the evaluation of the current speech. For example, for assessing the “in-world” QA metric, dialogue utterances from many characters may be collected, may be tagged per character, and a clustering analysis may be performed on lines (e.g., vectorizing with S-BERT, sentence2vec, or similar sentence-level embedding mechanisms, and then running any number of unsupervised clustering methods like t-SNE, k-means, for example). For assessing the story-world consistency of speech, the speech can be vectorized using the same method as used in the clustering analysis, and the distance between the speech vector and the character cluster centroid can be calculated. The smaller the distance, the more typical of the story-world is that speech.

Word frequencies can also be used for assessing whether speech is in-world. Other distribution similarity metrics have been proposed by Meister & Cotterell (2021), titled “Language Model Evaluation Beyond Perplexity,” (Proceedings of the 59th Annual Meeting of the Association for Computational Linguistics and the 11th International Joint Conference on Natural Language Processing, pages 5328-5339 Aug. 1-6, 2021), which is hereby incorporated fully by reference into the present application. Such other distribution similarity metrics could be employed to determine overlap versus distinction. Moreover, a very simplistic metric might be unigram-level distribution statistics (i.e., words/vocabulary); where the number of words in the generated speech that are in the original source vocabulary can be tallied up versus the number of words that are outside the original source vocabulary.

Regarding the feature “original source vocabulary” referenced above, it is noted that such an original source vocabulary includes the language included in the creative or historical corpus portraying a particular character. For example, the original source vocabulary of a character assuming the role of a fictional detective from 19^{th} century London, would include the language utilized in the creative works describing that fictional detective, but would typically not include ancient or modern usage inappropriate to the historical and geographical context of the 19th century London based detective.

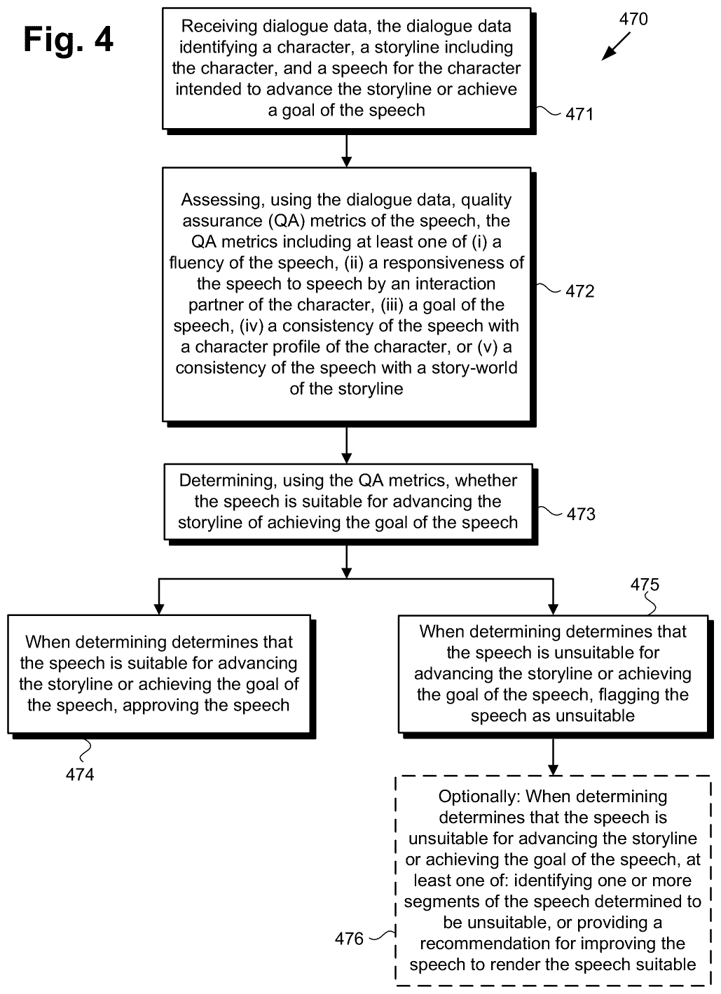

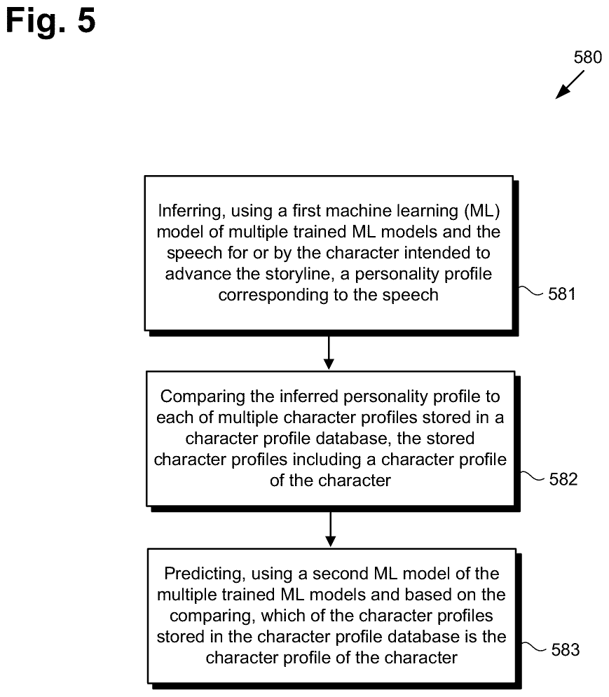

An approach combining psychological personality features and pre-trained large language ML models with a simple predictive algorithm can be used for judging whether generated interactions are “in-character.” Alternatively, or in addition, an entailment model may be used for judging in-character generated speech, comparing to previous source character dialogue lines and judging entailment, contradiction, or neutrality with regards to the new generated speech. In addition, or alternatively, another novel and inventive approach to assessing the in-character consistency of speech for a character may be employed, as described in greater detail below by reference to FIGS. 4 and 5.

With respect to the feature “entailment model,” it is noted that an entailment model predicts whether a statement is or is not true relative to an established predicate fact. For example, referring to the 19^{th} century London based detective character described above, speech by the character stating that the detective is presently investigating a case in Antarctica would be determined by an entailment model to be “in contradiction” rather than to be in an “entailment relationship” with the predicate fact that the character is a 19^{th} century London based detective. Alternatively, if speech by the detective describes travel though London via a Hansom cab, that speech would result in a determination of “entailment” by such a model.

In some implementations, the individual QA metrics described in the framework above may be combined into a single multi-faceted metric—with simple sums, or weighted sums—that can be used as a guide for training large language models or multimodal foundation models to generate speech. The combined QA metrics may be used in addition to the standard cross-entropy for language modeling prediction, such that during training, the model must attempt to optimize both for cross-entropy and this multi-faceted metric. Alternatively, or in addition, the individual or combined components may be used as part of a post-training process at generation time, to constrain the beam search for generation (e.g., the ranked next words predicted for the model are ranked not only according to the standard cross-entropy loss, but also according to the multi-faceted metric). This could be implemented with a future discriminator.

The functionality of software code 110 will be further described by reference to FIG. 4. FIG. 4 shows flowchart 470 presenting an exemplary method for performing character interaction quality evaluation, according to one implementation. With respect to the method outlined in FIG. 4, it is noted that certain details and features have been left out of flowchart 470 in order not to obscure the discussion of the inventive features in the present application.

Referring to FIG. 4, with further reference to FIG. 1, flowchart 470 includes receiving dialogue data 126 identifying a character, e.g., a character assumed by human performer 118 or represented by one of AI characters 116a or 116b, a storyline including the character, and a speech for the character intended to at least one of advance the storyline or achieve a goal of the speech (action 471). The speech identified by interaction data 126 may be speech generated by NLG 124 for intended use by one of AI characters 116a or 116b representing the character in an interaction with human speaker 114, or may be speech actually uttered by human performer 118 assuming the role of the character.

In implementations in which the speech identified by interaction data 126 is speech for intended use by one of AI characters 116a or 116b representing the character in an interaction with human speaker 114, dialogue data 126 may be received by system 100 from NLG 124, via communication network 150 and network communication links 152. Moreover, it is noted that in some implementations in which the speech identified by interaction data 126 is speech for intended use by one of AI characters 116a or 116b representing the character in an interaction with human speaker 114, that speech may include multiple alternative lines of dialogue for use by the character.

In implementations in which the speech identified by dialogue data 126 is speech actually uttered by human performer 118 assuming the role of the character, dialogue data 126 may be received from a recording device or transmitter worn by human performer 118 or situated in a performance venue in which the portrayal of the character by human performer 118 occurs, via communication network 150 and network communication links 152. Referring to FIG. 3A, whether received from NLG 124 or as a result of speech actually uttered by human performer 118, dialogue data 126 may describe the story-world of the character, and the context and goal of an interaction by the character, as well as the dialogue history of the character and a continuation of the dialogue. Moreover, whether received from NLG 124 or as a result of speech actually uttered by human performer 118, dialogue data 126 may be received, in action 471, by software code 110, executed by hardware processor 104 of system 100.

Continuing to refer to FIGS. 1 and 4 in combination, flowchart 470 further includes assessing, using dialogue data 126, QA metrics of the speech, the QA metrics including at least one of: (i) a fluency of the speech, (ii) a responsiveness of the speech to speech by an interaction partner of the character, e.g., human speaker 114, (iii) the goal of the speech, (iv) a consistency of the speech with a character profile of the character, or (v) a consistency of the speech with a story-world of the storyline (action 472). As noted above, in some implementations the individual QA metrics (i) a fluency of the speech, (ii) a responsiveness of the speech to speech by an interaction partner of the character, (iii) the goal of the speech, (iv) a consistency of the speech with a character profile of the character, or (v) a consistency of the speech with a story-world of the storyline may be combined to form an integrated multi-faceted evaluation metric that may be applied to the speech in action 472.

Moreover, and as further noted above, system 100 includes ML model(s) 128. In some implementations, the assessment of one or more of the QA metrics included in the framework identified above may be performed using at least one trained ML model included in ML model(s) 128. Furthermore, it is noted that in implementations in which the assessment of one or more of those QA metrics is performed using at least one trained ML model, that at least one trained ML model may include one or more of a large language model or a multimodal foundation model.

With respect to the QA metric for assessing the consistency of the speech identified by dialogue data 126 with the story-world of the storyline including the character, it is noted that this QA metric may be assessed by generating a vector projection of the speech into an embedding space and comparing the vector projection of the speech with a vector representation in the embedding space of a description of the story-world. It is further noted that such a comparison may include computing a cosine similarity of the vector projection of the speech and the vector representation of the description of the story-world or a Euclidean distance of the vector projection of the speech from the vector representation of the story-world. The assessment of the QA metrics of the speech identified by dialogue data 126, in action 472, may be performed by software code 110, executed by hardware processor 104 of system 100.

Alternatively, or in addition, in some implementations, the assessment of the QA metrics of the speech identified by dialogue data 126 may include manual review and assessment of those metrics, using UI 112, as shown by the exemplary representations shown by FIGS. 3A and 3B. In those implementations hardware processor 104 of system 100 may further execute the software code 110 to display, via UI 112, a summary of the dialogue data for review by a system administrator of system 100, who, as noted above, may be a programmer or language editor for example. In those implementations, assessing the QA metrics of the speech identified by dialogue data 126 may include receiving one or more evaluations of the speech as an input or inputs from the system administrator via UI 112. Moreover, in those implementations the one or more evaluations of the speech received as the input or inputs from the user system via UI 112 may be used to further train or retrain any of ML model(s) 128 used in the assessment performed in action 472, or to train another or new ML model to perform such an assessment.

As noted above, in some implementations, the QA metrics assessed in action 472 may include (iv) consistency of the speech identified by dialogue data 126 with a character profile of the character. FIG. 5 shows flowchart 580 describing additional actions for assessing the consistency of speech generated for a character with the character profile of the character, according to one implementation. Referring to FIG. 5 in combination with FIG. 1, according to the exemplary approach outlined in FIG. 5, flowchart 580 includes inferring, using a first trained ML model of ML model(s) 128 and the speech identified by dialogue data 126, a personality profile corresponding to the speech (action 581).

It is noted that the trained ML model used to infer the personality profile corresponding to the speech identified by dialogue data 126 may be or include a large language model or a multimodal foundation model. Action 581 may be performed, as part of action 472 in some implementations, by software code 110, executed by hardware processor 104 of system 100, and using ML model(s) 128.

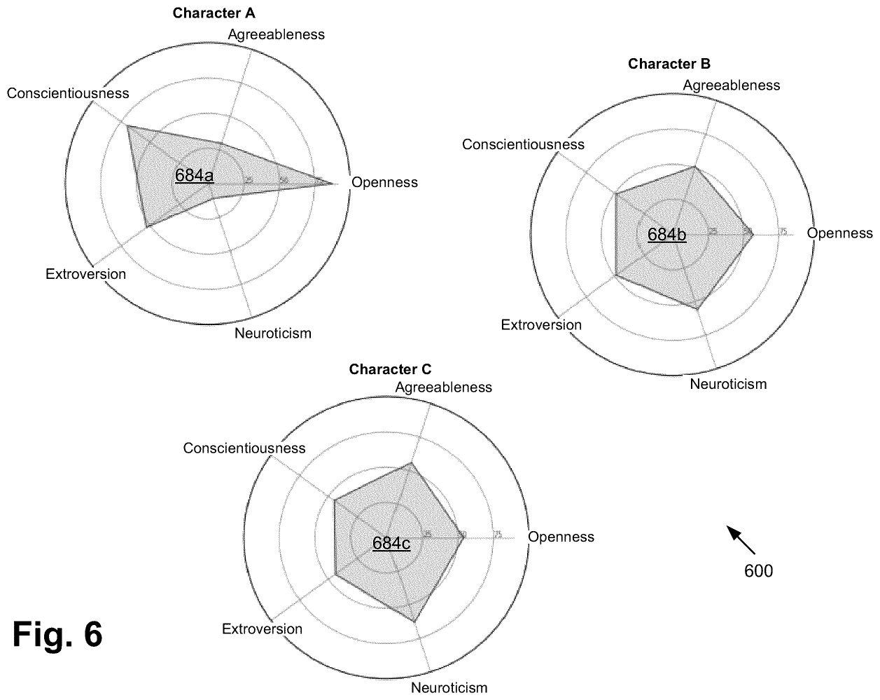

Continuing to refer to FIGS. 1 and 5 in combination, flowchart 580 further includes comparing the personality profile inferred in action 581 to each of character profiles 122a, 122b and 122c stored in character profile database 120, where character profiles 122a, 122b and 122c include the character profile of the character (action 582). Referring to FIG. 6, FIG. 6 shows diagram 600 depicting character trait clusters for different characters relative to Big 5 personality traits, according to one implementation. It is noted that, as known in the art, the Big 5 personality traits include the traits: openness, conscientiousness, agreeableness, extroversion, and neuroticism. FIG. 6 shows character trait clusters 684a, 684b and 684c (hereinafter “character trait clusters 684a-684c”) corresponding respectively to Character A, Character B and Character C. Character trait clusters 684a-684c depict projections of the personality profiles of respective Characters A, B and C onto a multi-dimensional embedding space based on the Big 5 traits.

Thus, in some implementations, the comparison performed in action 582 may include comparing the personality profile inferred in action 581 with character profiles 122a, 122b and 122c stored in character profile database 120 using clustering based on the Big 5 personality traits of openness, conscientiousness, agreeableness, extroversion, and neuroticism. However, it is noted that in other implementations, other personality models may be used as an alternative to the Big 5 personality traits. One example of such an alternative may be based on the Myers Briggs personality types, as known in the art. Furthermore, in yet other implementations, a custom personality model may be generated for a specific character or a specific group of characters and that custom personality model may be used in lieu of conventional personality models, such as those based on the Big 5 traits or the Myers Briggs personality types, for example. The comparison in action 582 may be performed by software code 110, executed by hardware processor 104 of system 100.

Continuing to refer to FIGS. 1 and 5 in combination, flowchart 580 further includes predicting, using a second trained ML model of ML model(s) 128 and based on the comparison performed in action 582, which of character profiles 122a, 122b, or 122c stored in character profile database 120 is the character profile of the character identified by dialogue data 124 (action 583). Action 583 may be performed by software code 110, executed by hardware processor 104 of system 100, and using a regression model included among ML model(s) 128.

It is noted that the actions outlined by flowchart 580 do not attempt to directly administer a personality quiz to an ML model such as a large language model or multimodal foundation model, in action 581, but rather prompts that model to analyze a given speech along a particular personality dimension. The judgment of what personality belongs to the character intended to utter the speech is produced by a separate regression model in action 583. According to the approach outlined by flowchart 580, the large language model or multimodal foundation model utilized in action 581 is used in a discriminative manner, as opposed to a generative one, and in contrast to conventional approaches to detecting personality, the underlying “persona” of the large language model or multimodal foundation model is immaterial. According to the approach disclosed herein, and large language model or multimodal foundation model can be used in conjunction with the regression model utilized in action 583 fit to its judgments. In other words, the large language model or multimodal foundation model utilized in action 581 merely produces the features by which the regression model utilized in action 583 judges personality. This feature makes the system disclosed herein flexible with respect to implementation, and more robust to potential underlying differences in personality of large language models or multimodal foundation models.

Referring once again to FIG. 4 in combination with FIG. 1, flowchart 470 further includes determining, using the QA metrics, whether the speech identified by dialogue data 126 is suitable for advancing the storyline identified by dialogue data 126 or is suitable for advancing the goal of the speech (action 473). As noted above, the determination performed in action 473 may be based on manual inputs to system 100 by a system administrator via UI 112, or in an automated process, which in some implementation may include use of one or more of ML model(s) 128. The determination as to whether the speech identified by dialogue data 126 is suitable for advancing the storyline identified by dialogue data 126 or for achieving the goal of the speech, in action 473, may be performed by software code 110, executed by hardware processor 104 of system 100.

As noted above, in some use cases, the speech identified by interaction data 126 may include multiple alternative lines of dialogue. In those use cases, action 473 may include determining, from among those alternative lines of dialogue, a best speech for advancing the storyline also identified by dialogue data 126 or for achieving the goal of the speech. Moreover, in those use cases, the method outlined by flowchart 470 may conclude with such a determination as to which of the alternative lines of dialogue constitutes the best speech. When the speech identified by interaction data 126 includes multiple alternative lines of dialogue, the determination of which of those lines of dialogue is the best speech for advancing the storyline or achieving the goal may be performed by software code 110, executed by hardware processor 104 of system 100.

However, in other use cases, and as shown by FIG. 4, when action 473 results in the determination that the speech identified by dialogue data 126 is suitable for advancing the storyline identified in dialogue data 126 or achieving the goal of the speech, the method outlined by FIG. 4 may further include approving the speech (action 474). Action 474 may be performed by software code 110, executed by hardware processor 104 of system 100 and may include generating an internal flag approving the speech, or may include communicating approval of the speech to a system administrator via UI 112. However, it is noted that action 474 is contingent upon the determination that the speech identified by dialogue data 126 is suitable for advancing the storyline identified in dialogue data 126 or achieving the goal of the speech. In use cases in which that determination is not made, action 474 does not occur, and the method outlined by flowchart 470 omits proceeds directly from action 473 to action 475 described below.

The method outlined by flowchart 470 may further include, when action 473 results in the determination that the speech identified by dialogue data 126 is unsuitable for advancing the storyline identified in dialogue data 126 or achieving the goal of the speech, flagging the speech as unsuitable (action 474). Action 475 may be performed by software code 110, executed by hardware processor 104 of system 100, and may include generating an internal flag of unsuitability of the speech, or may include communicating the unsuitability of the speech to a system administrator via UI 112. Analogously to action 474, it is noted that action 475 is contingent upon the determination that the speech identified by dialogue data 126 is unsuitable for advancing the storyline identified in dialogue data 126. In use cases in which that determination is made in action 474 that the speech identified by dialogue data 126 is suitable for advancing the storyline identified by dialogue data 126, the method outlined by flowchart 470 may conclude with action 474 and action 475 may be omitted.

In some implementations, the method outlined by flowchart 470 may further include, when action 473 results in the determination that the speech identified by dialogue data 126 is unsuitable for advancing the storyline identified in dialogue data 126 or achieving the goal of the speech, identifying one or more segments of the speech determined to be unsuitable, and/or providing a recommendation for improving the speech to render the speech suitable (action 476).

It is noted that action 476 is optional, and in some implementations in which the method outlined by flowchart 470 omits action 474 but includes action 475, action 476 may be omitted and the method may conclude with action 475. In implementations in which the method outlined by flowchart 470 does include optional action 476, action 476 may be performed by software code 110, executed by hardware processor 104 of system 100. For example, in use cases in which the speech identified by dialogue data 126 includes one or more words that are not included in the original source vocabulary for the character, hardware processor 104 of system 100 may execute software code 110 to replace those one or more unsuitable words with synonyms or analogues that are included in the original source vocabulary.

Referring to FIGS. 1, 4 and 5 in combination, it is also noted that, with respect to the method outlined by flowcharts 470 and 580, actions 471, 472 and 473 (hereinafter “actions 471-473”) and action 474, or actions 471-473 and action 475, or actions 471-473, 475 and 476, where, in some implementations, action 472 may further include actions 581, 582 and 583, may be performed as an automated process from which human participation may be omitted.

Thus, the present application discloses systems and methods for performing entertainment character interaction quality evaluation and improvement that address and overcome the deficiencies in the conventional art. To that end, the present application discloses multiple QA metrics, which in some implementations may be combined to provide a multi-faceted evaluation metric. Those QA metrics or that multi-faceted metric can be used to judge the goodness of fit of generative language models to a specified entertainment character, which may be an AI character or a human performer assuming the role of the character for example.

It is also contemplated that the QA metrics and multi-faceted evaluation metric disclosed herein may be used in a substantially automated pipeline that generates speech for a character to: (a) exclude and regenerate certain utterances that are deemed unsuitable due to failing one or several evaluation metrics, and (b) in certain use cases to automatically alter utterances and reprocess the altered utterance with the same metrics to ensure that the character speech is consistent with human conversational behavior, the communication goals of the character, and the character profile, e.g., personality of the character. By way of example, if the only deficiency in a generated speech for an AI character refers to the AI character as a young female (“girl”) character where its persona is in fact that of a young male (“boy”), the original line of dialogue including that reference would be determined to be unsuitable due to character inconsistency. Once the word boy is substituted for the word girl in the speech, however, the speech would then pass all the metrics tests and be determined to be suitable. That is to say, in use cases in which a plurality of QA metrics are applied individually, the speech would satisfy all of those QA metrics, while in use cases in which a multi-faceted QA metric is applied, the speech would satisfy that multi-faceted QA metric as a whole.

It is noted that although in some implementations the pipeline described above can be fully automated (i.e., no human in the loop), in other implementations such a pipeline may be used to filter and improve lines of dialogue in speech for a character that are presented to a human expert for review and/or revision. It is further noted that the QA metrics and multi-faceted evaluation metric disclosed herein can advantageously provide a basis for better model research in the future, and allow for potential control along those metrics or metric facets for ongoing improvement of the model.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a memory storing a software code;
the hardware processor configured to execute the software code to:
receive dialogue data, the dialogue data identifying a character, a storyline including the character, and a speech for the character intended to at least one of advance the storyline or achieve a goal of the speech;
assess, using the dialogue data, a plurality of quality assurance (QA) metrics of the speech, the plurality of QA metrics including at least one of: (i) a fluency of the speech, (ii) a responsiveness of the speech to speech by an interaction partner of the character, (iii) a consistency of the speech with the goal of the speech, (iv) a consistency of the speech with a character profile of the character, or (v) a consistency of the speech with a story-world of the storyline;
determine, using the plurality of QA metrics, whether the speech is suitable for advancing the storyline;
when determining determines that the speech is suitable for advancing the storyline or achieving the goal, approve the speech; and
when determining determines that the speech is unsuitable for advancing the storyline or achieving the goal, flag the speech as being unsuitable.

2. The system of claim 1, wherein when determining determines that the speech is unsuitable for advancing the storyline or achieving the goal, the hardware processor is further configured to execute the software code to:
at least one of: identify one or more segments of the speech determined to be unsuitable, or provide a recommendation for improving the speech to render the speech suitable.

3. The system of claim 1, wherein the hardware processor is further configured to execute the software code to:
display, via a user interface (UI), a summary of the dialogue data for review by a system administrator; and
wherein assessing the plurality of QA metrics includes receiving one or more evaluations of the speech as input from the system administrator via the UI.

4. The system of claim 1, further comprising:
at least one trained machine learning (ML) model;
wherein assessing at least one of the plurality of QA metrics is performed using the at least one trained ML model.

5. The system of claim 4, wherein the at least one trained ML model comprises at least one of a large language model or a multimodal foundation model.

6. The system of claim 4, wherein to assess the consistency of the speech with the character profile of the character, the hardware processor is further configured to execute the software code to:
infer, using a first ML model of the at least one trained ML model and the speech, a personality profile corresponding to the speech;
compare the inferred personality profile to each of a plurality of character profiles stored in a character profile database, the plurality of character profiles including the character profile of the character; and
predict, using a second ML model of the at least one trained ML model and based on the comparing, which of the plurality of character profiles stored in the character profile database is the character profile of the character.

7. The system of claim 6, wherein the first ML model comprises one of a large language model or a multimodal foundation model, and wherein the second ML model comprises a regression model.

8. The system of claim 6, wherein the inferred personality profile and the plurality of character profiles are compared using clustering based on personality traits comprising openness, conscientiousness, agreeableness, extroversion, and neuroticism.

9. The system of claim 1, wherein to assess the consistency of the speech with the story-world of the storyline, the hardware processor is further configured to execute the software code to:
generate a vector projection of the speech into an embedding space; and
compare the vector projection of the speech with a vector representation of a description of the story-world;
wherein comparing comprises one of computing (i) a cosine similarity of the vector projection and the vector representation, or (ii) a Euclidean distance of the vector projection from the vector representation.

10. A method for use by a system having a hardware processor and a memory storing a software code, the method comprising:
receiving, by the software code executed by the hardware processor, dialogue data, the dialogue data identifying a character, a storyline including the character, and a speech for the character intended to at least one of advance the storyline or achieve a goal of the speech;
assessing, by the software code executed by the hardware processor and using the dialogue data, a plurality of quality assurance (QA) metrics of the speech, the plurality of QA metrics including at least one of: (i) a fluency of the speech, (ii) a responsiveness of the speech to speech by an interaction partner of the character, (iii) a consistency of the speech with the goal of the speech, (iv) a consistency of the speech with a character profile of the character, or (v) a consistency of the speech with a story-world of the storyline;
determining, by the software code executed by the hardware processor and using the plurality of QA metrics, whether the speech is suitable for advancing the storyline;
when determining determines that the speech is suitable for advancing the storyline or achieving the goal, approving, by the software code executed by the hardware processor, the speech; and
when determining determines that the speech is unsuitable for advancing the storyline or achieving the goal, flagging, by the software code executed by the hardware processor, the speech as being unsuitable.

11. The method of claim 10, further comprising:
when determining determines that the speech is unsuitable for advancing the storyline or achieving the goal, at least one of identifying, by the software code executed by the hardware processor, one or more segments of the speech determined to be unsuitable, or providing, by the software code executed by the hardware processor, a recommendation for improving the speech.

12. The method of claim 10, further comprising:
displaying, by the software code executed by the hardware processor via a user interface (UI), a summary of the dialogue data for review by a system administrator; and
wherein assessing the plurality of QA metrics includes receiving one or more evaluations of the speech as input from the system administrator via the UI.

13. The method of claim 10, wherein the system further comprises at least one trained machine learning (ML) model;
wherein assessing at least one of the plurality of QA metrics is performed using the at least one trained ML model.

14. The method of claim 13, wherein the at least one trained ML model comprises at least one of a large language model or a multimodal foundation model.

15. The method of claim 13, wherein assessing the consistency of the speech with the character profile of the character comprises:
inferring, by the software code executed by the hardware processor and using a first ML model of the at least one trained ML model and the speech, a personality profile corresponding to the speech;
comparing, by the software code executed by the hardware processor, the inferred personality profile to each of a plurality of character profiles stored in a character profile database, the plurality of character profiles including the character profile of the character; and
predicting, by the software code executed by the hardware processor using a second ML model of the at least one trained ML model and based on the comparing, which of the plurality of character profiles stored in the character profile database is the character profile of the character.

16. The method of claim 15, wherein the first ML model comprises one of a large language model or a multimodal foundation model, and wherein the second ML model comprises a regression model.

17. The method of claim 15, wherein the inferred personality profile and the plurality of character profiles including the character profile of the character are compared using clustering based on personality traits including openness, conscientiousness, agreeableness, extroversion, and neuroticism.

18. The method of claim 10, wherein assessing the consistency of the speech with the story-world of the storyline comprises:
generating, by the software code executed by the hardware processor, a vector projection of the speech into an embedding space; and
comparing, by the software code executed by the hardware processor, the vector projection of the speech with a vector representation in the embedding space of a description of the story-world;
wherein comparing comprises one of computing a cosine similarity of the vector projection and the vector representation or a Euclidean distance of the vector projection from the vector representation.

19. A system comprising:
a hardware processor; and
a memory storing a software code;
the hardware processor configured to execute the software code to:
receive dialogue data, the dialogue data identifying a character, a storyline including the character, and a speech for the character intended to at least one of advance the storyline or achieve a goal of the speech, the speech including a plurality of alternative lines of dialogue;
assess, using the dialogue data, a plurality of quality assurance (QA) metrics of the speech, the plurality of QA metrics including at least one of: (i) a fluency of the speech, (ii) a responsiveness of the speech to speech by an interaction partner of the character, (iii) a consistency of the speech with the goal of the speech, (iv) a consistency of the speech with a character profile of the character, or (v) a consistency of the speech with a story-world of the storyline; and
determine, using the plurality of QA metrics, one of the alternative lines of dialogue as a best speech to advance the storyline or achieve the goal.

20. The system of claim 19, further comprising a plurality of trained machine learning (ML) models, wherein to assess the consistency of the speech with the character profile of the character, the hardware processor is further configured to execute the software code to:
infer, using a first ML model of the plurality of trained ML models and the speech, a personality profile corresponding to the speech;
compare the inferred personality profile to each of a plurality of character profiles stored in a character profile database, the plurality of character profiles including the character profile of the character; and
predict, using a second ML model of the plurality of trained ML models and based on the comparing, which of the plurality of character profiles stored in the character profile database is the character profile of the character.
